(19) United States
(12) Patent Application Publication
(10) Pub. No.: US 2026/0010868 A1
(43) Pub. Date: Jan. 8, 2026

(54) WORK INSTRUCTION APPARATUS AND WORK INSTRUCTION METHOD

(71) Applicant: Toshiba Tec Kabushiki Kaisha, Tokyo (JP)

(72) Inventor: Takashi ICHIKAWA, Tagata Shizuoka (JP)

(21) Appl. No.: 19/178,082

(22) Filed: Apr. 14, 2025

(30) Foreign Application Priority Data
Jul. 3, 2024 (JP) 2024-107176

(51) Int. Cl. G06Q 10/087; G01C 21/20

(52) U.S. Cl. CPC G06Q 10/087; G01C 21/206

(57) ABSTRACT

In accordance with an embodiment, a work instruction apparatus obtains item transportation information including information for identifying a cart (item) moved by a worker and information for identifying a headset worn by the worker. The work instruction apparatus generates, on the basis of the item transportation information and a storage location of the cart, navigation information including a route for moving the cart to the storage location or to a stop to the storage location from a current location. The work instruction apparatus converts the generated navigation information into audio information and causes the headset worn by the worker to output the audio information.

### CROSS-REFERENCE TO RELATED APPLICATIONS

This application is based upon and claims the benefit of priority from the prior Japanese Patent Application No. 2024-107176, filed on July 3, 2024, the entire contents of which are incorporated herein by reference.

### FIELD

An embodiment described here generally relates to a work instruction apparatus and a work instruction method for the work instruction apparatus.

### BACKGROUND

Conventionally, there is a known work instruction apparatus that assists transportation work of moving items transported by a truck or the like to a storage container at a warehouse that contains items, such as products. With such a work instruction apparatus, a worker moves items to the storage container while reading identification information of the items with a portable terminal held by the worker, such as a handheld scanner, and checking a destination and the like displayed on the portable terminal.

With such a conventional work instruction apparatus, the worker needs to operate the portable terminal with his or her own hands. The worker also needs to check destination information and the like displayed on the portable terminal, so the worker may not pay sufficient attention to the surrounding environment. It is thus desirable to realize a work instruction apparatus that enables the worker to transport an item with both hands while paying attention to the surroundings.

### BRIEF DESCRIPTION OF THE DRAWINGS

FIG. 1 is a block diagram showing an example of a schematic configuration of a work instruction system according to an embodiment.

FIG. 2 is a hardware block diagram showing an example of a hardware configuration of a work instruction apparatus of the work instruction system according to the embodiment.

FIG. 3 is a diagram showing an example of a data structure of an item master stored by the work instruction apparatus according to the embodiment.

FIG. 4 is a diagram showing an example of a prompt generated by the work instruction apparatus according to the embodiment.

FIG. 5 is a first diagram showing an example of navigation information generated by the work instruction apparatus according to the embodiment.

FIG. 6 is a second diagram showing an example of the navigation information generated by the work instruction apparatus according to the embodiment.

FIG. 7 is a functional block diagram showing an example of a functional configuration of the work instruction apparatus according to the embodiment.

FIG. 8 is a flowchart showing an example of processing performed by the work instruction system according to the embodiment.

### DETAILED DESCRIPTION

In accordance with one embodiment, a work instruction apparatus assists transportation work of a worker moving an item to a storage location. The work instruction apparatus includes a communication device, a storage device, and a controller. The communication device is installed in a predetermined location on a transportation route on which an item is moved and wirelessly communicates with a reading device that reads information for identifying the item transported by the worker and information for identifying a headset worn by the worker. The storage device includes an item master in which the storage location of the item is stored corresponding to the information for identifying the item. The controller obtains item transportation information from the reading device via the communication device, the item transportation information including the information for identifying the item transported by the worker and the information for identifying the headset worn by the worker. The controller refers to the item master and checks the storage location of the item corresponding to the obtained information for identifying the item. The controller generates navigation information on the basis of the item transportation information and the checked storage location of the item, the navigation information including a route for moving the item to the storage location or to a stop to the storage location from a current location. The controller converts the generated navigation information into audio information. In addition, the controller causes the headset worn by the worker to output the audio information.

Hereinafter, the embodiment will be further described with reference to the drawings. In the drawings, the same reference signs denote the same or similar parts.

### (Schematic Configuration of Work Instruction System)

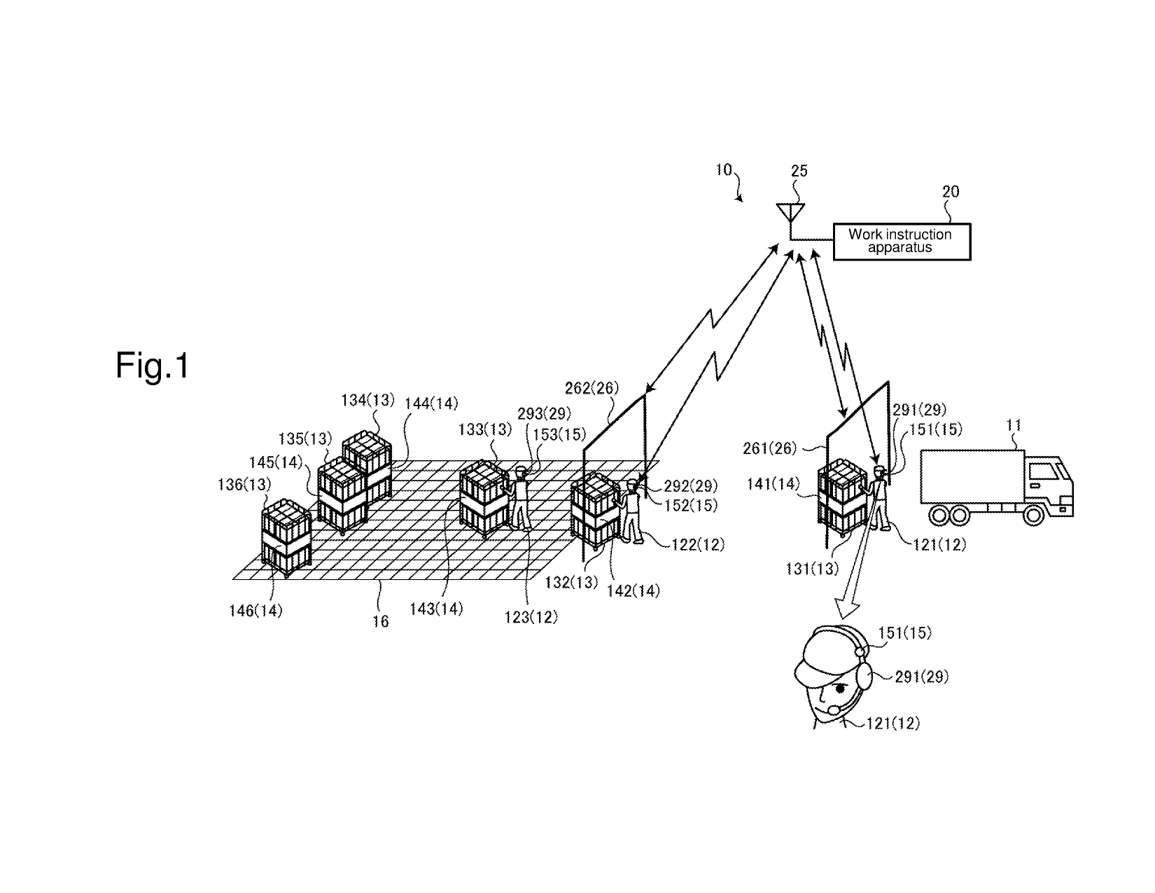

Referring to FIG. 1, a schematic configuration of a work instruction system 10 that is the embodiment of the present disclosure will be described. FIG. 1 is a block diagram showing an example of the schematic configuration of the work instruction system according to the embodiment.

As shown in FIG. 1, the work instruction system 10 includes a work instruction apparatus 20, an RFID reader (wireless reader) 26, and a headset 29 worn by a worker 12.

The work instruction system 10 directs a storage location of a cart 13 in a storage container 16 to the worker 12 wearing the headset 29 and moving the cart 13 via the headset 29. The cart 13 is an example of an item in the present disclosure.

The work instruction apparatus 20 obtains identification information for uniquely identifying the cart 13 moved by the worker 12, a current location of the cart 13, identification information for uniquely identifying the headset 29 worn by the worker 12, and a current location of the headset 29. Then, the work instruction apparatus 20 calculates a movement path from the current location of the cart 13 to the storage location in the storage container 16. Moreover, the work instruction apparatus 20 generates navigation information that directs a route of the calculated movement path. In addition, the work instruction apparatus 20 converts the generated navigation information into audio information and causes the headset 29 worn by the worker 12 to output the audio information.

An RFID tag 14 is attached to a side or upper surface of the cart 13. The identification information for uniquely identifying the cart 13 has been registered on the RFID tag 14. Moreover, an RFID tag 15 is attached to the headset 29. The identification information for uniquely identifying the headset 29 is registered on the RFID tag 15. It should be noted that the RFID tag 14 and the RFID tag 15 are examples of a wireless tag in the present disclosure.

The identification information for uniquely identifying the cart 13 and the identification information for uniquely identifying the headset 29 are read by the RFID reader 26 installed in a gate when the worker 12 passes through the gate while moving the cart 13. The work instruction apparatus 20 wirelessly communicates with the RFID reader 26 via an antenna 25 and obtains the identification information of the cart 13 and the identification information of the headset 29 together with identification information for identifying the RFID reader 26. The antenna 25 is an example of a communication device of the work instruction apparatus 20. The work instruction apparatus 20 has stored an installation location of the RFID reader 26. The work instruction apparatus 20 recognizes that the cart 13 and the worker 12 are located in the installation location of the RFID reader 26 on the basis of the fact that the identification information of the cart 13 and the identification information of the headset 29 have been read by the RFID reader 26.

The RFID reader 26 (261) is provided in a location where items transported by the transportation vehicle 11 are unloaded and loaded onto the cart 13. Moreover, a plurality of RFID readers 26 is installed at required locations on the way on which the cart 13 arrives at the storage container 16. FIG. 1 is an example in which the RFID readers 26 are installed at two locations.

In general, a plurality of workers 12 moves the carts 13. Therefore, as shown in FIG. 1, a plurality of carts 13 (131, 132, 133, 134, 135, and 136) is present and different RFID tags 14 (141, 142, 143, 144, 145, and 146) are respectively attached to the carts 13. Also, a plurality of workers 12 (121, 122, and 123) is present. In addition, the plurality of workers 12 each wears a different headset 29. That is, a plurality of headsets 29 (291, 292, and 293) is also present and different RFID tags 15 (151, 152, and 153) are respectively attached to the headsets 29. Hereinafter, they will be simply referred to as the cart 13, the worker 12, the headset 29, the RFID tag 14, and the RFID tag 15 when it is unnecessary to distinguish them.

### (Hardware Configuration of Work Instruction Apparatus)

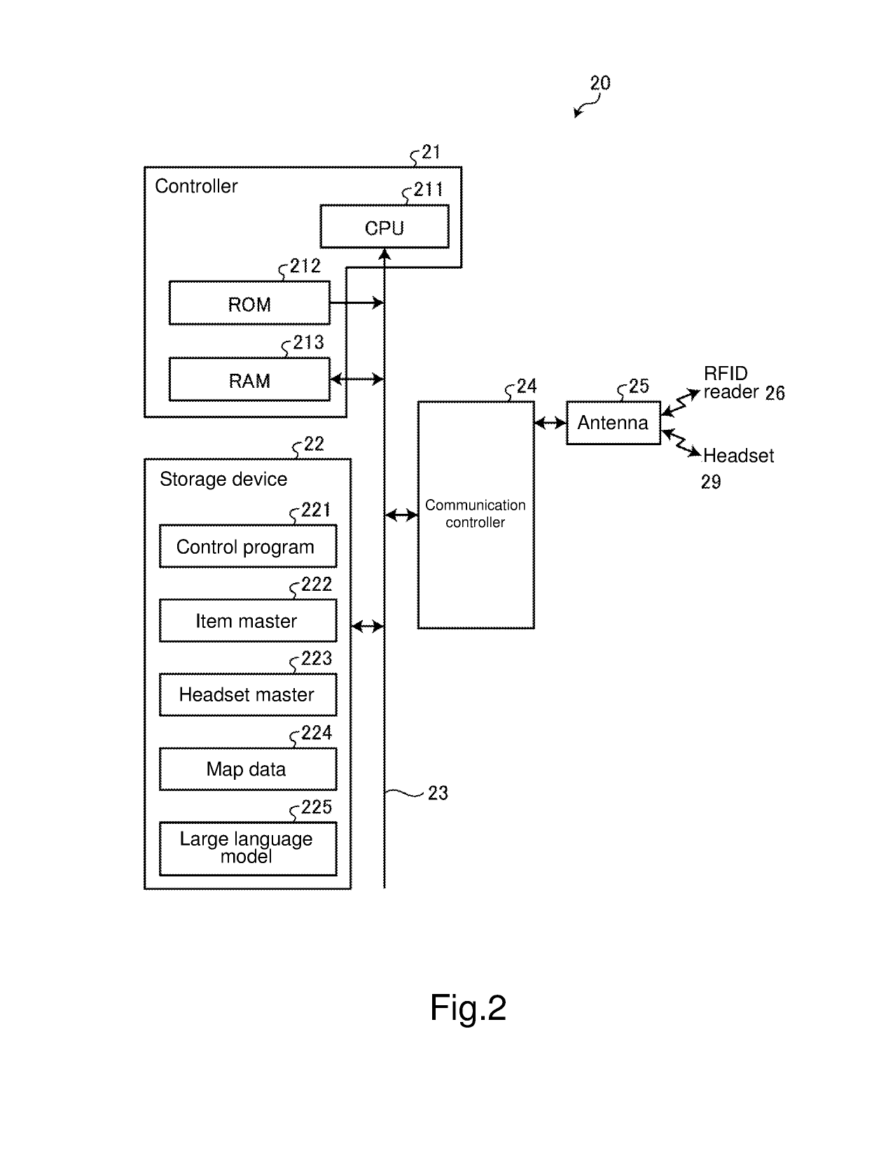

Referring to FIG. 2, a hardware configuration of the work instruction apparatus 20 will be described. FIG. 2 is a hardware block diagram showing an example of the hardware configuration of the work instruction apparatus 20 of the work instruction system 10 according to the embodiment.

The work instruction apparatus 20 has a configuration in which a controller 21, a storage device 22, and a communication controller 24 are connected to one another via an internal bus 23.

The controller 21 controls comprehensive operations of the work instruction apparatus 20. The controller 21 includes a central processing unit (CPU) 211, a read only memory (ROM) 212, and a random access memory (RAM) 213. The CPU 211 connects the ROM 212 and the RAM 213 via the internal bus, such as an address bus or data bus. The CPU 211 expands various programs stored on the ROM 212 or the storage device 22 to the RAM 213. The CPU 211 controls the operations of the work instruction apparatus 20 by operating in accordance with the various programs expanded to the RAM 213. That is, the controller 21 has a general-purpose computer configuration. It should be noted that the configuration of the controller 21 is not limited thereto, and, for example, a configuration in which the CPU 211 is directly connected to the ROM 212 and the RAM 213 without the internal bus 23 may be employed.

The storage device 22 is a storage device, such as a hard disk drive (HDD) or solid state drive (SSD). Moreover, the storage device 22 may be a nonvolatile memory that holds stored information also after it is powered off, such as a flash memory. The storage device 22 stores a control program 221, an item master 222, a headset master 223, map data 224, and a large language model 225.

The control program 221 is a program that controls comprehensive operations of the work instruction apparatus 20. The control program 221 may be provided, stored on the storage device 22. Alternatively, the control program 221 may be provided, recorded on a computer-readable non-transitory recording medium, such as a CD-ROM, flexible disk (FD), CD-R, or DVD, in an installable or executable format. Alternatively, the control program 221 may be stored on a computer connected to a network, downloaded via the network, and provided. Alternatively, the control program 221 may be provided or delivered via a network, such as the Internet.

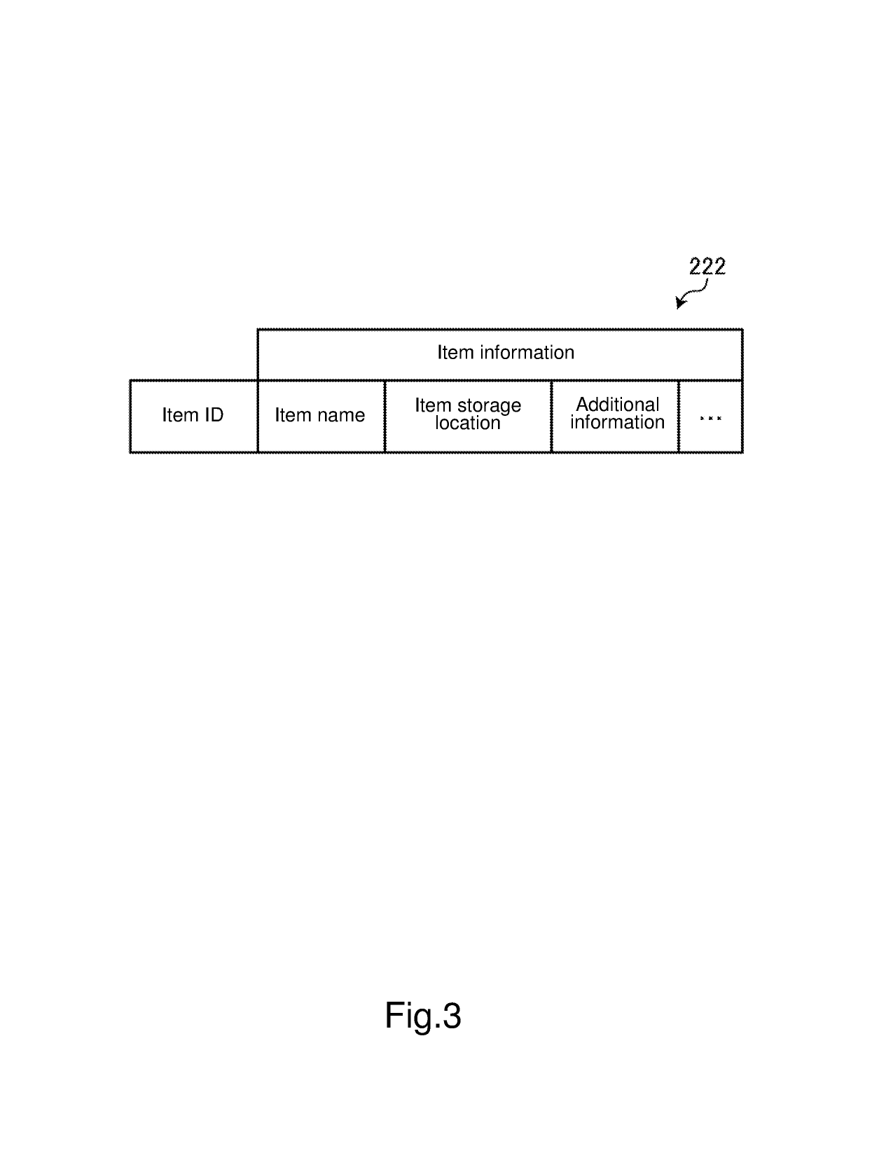

The item master 222 is a master file that has stored a storage location of the cart 13 moved by the worker 12 in the storage container 16, and the like. A data structure of the item master 222 will be described later in detail (see FIG. 3).

The headset master 223 is a master file that has stored the identification information for uniquely identifying the headset 29 used by the worker 12.

The map data 224 is map data that covers an area from a location where the cart 13 loaded with the items transported by the transportation vehicle 11 is unloaded or a location where the items transported by the transportation vehicle 11 are put on the cart 13 to the storage container 16 for storing the carts 13. The map data 224 includes linear information of a pathway on which the cart 13 can pass, location information of corners and junctions of the pathway, installation locations of the gates provided with the RFID readers 26, and location information of the storage location of the cart 13 in the storage container 16. It should be noted that the map data 224 can have any data structure.

The large language model 225 is also called LLM, and is a language model used for performing natural language processing on a set generation condition (prompt), thereby generating teaching information in a natural language according to a generation condition. The large language model 225 is built by performing deep learning-based training on a mass of text data. In particular, the large language model 225 used in the present embodiment is a language model that has been learned for generating the navigation information that directs the route to move the cart 13 to the storage location in the storage container 16. It should be noted that although the present embodiment employes a configuration in which the work instruction apparatus 20 itself includes the large language model 225 and generates the navigation information, a configuration in which the large language model 225 is stored on a calculator independent of the work instruction apparatus 20 and the calculator generates navigation information by using the large language model 225 in response to a prompt generated by the work instruction apparatus 20 and outputs the generated navigation information to the work instruction apparatus 20 may be employed because the amount of data of the large language model 225 is large.

The controller 21 performs various types of communication with the antenna 25 via the communication controller 24. The antenna 25 obtains the identification information for uniquely identifying the cart 13, which has been registered on the RFID tag 14 attached to the cart 13, from the RFID reader 26. Moreover, the antenna 25 obtains the identification information for uniquely identifying the headset 29, which has been registered on the RFID tag 15 attached to the headset 29 worn by the worker 12, from the RFID reader 26.

### (Data Structure of Item Master)

Referring to FIG. 3, the data structure of the item master 222 will be described. FIG. 3 is a diagram showing an example of the data structure of the item master stored by the work instruction apparatus.

The item master 222 stores various types of item information in association with an item ID that is the identification information for uniquely identifying the cart 13.

The item information stored by the item master 222 includes, for example, an item name, an item storage location, additional information, and the like. The item name is a name given to the item. The item storage location is a storage location of the information for identifying the item with the item ID. The item storage location indicates, for example, a storage location in the storage container 16 (see FIG. 1). More specifically, latitude and longitude of the storage location, a section number of the storage location, and the like are stored as the item storage location. The item storage location is information with contents capable of uniquely identifying the location in the map data 224 (see FIG. 2). The additional information includes matters that require attention during the transportation, e.g., "THIS WAY UP" and "FRAGILE."

### (Prompt Generated by Work Instruction Apparatus)

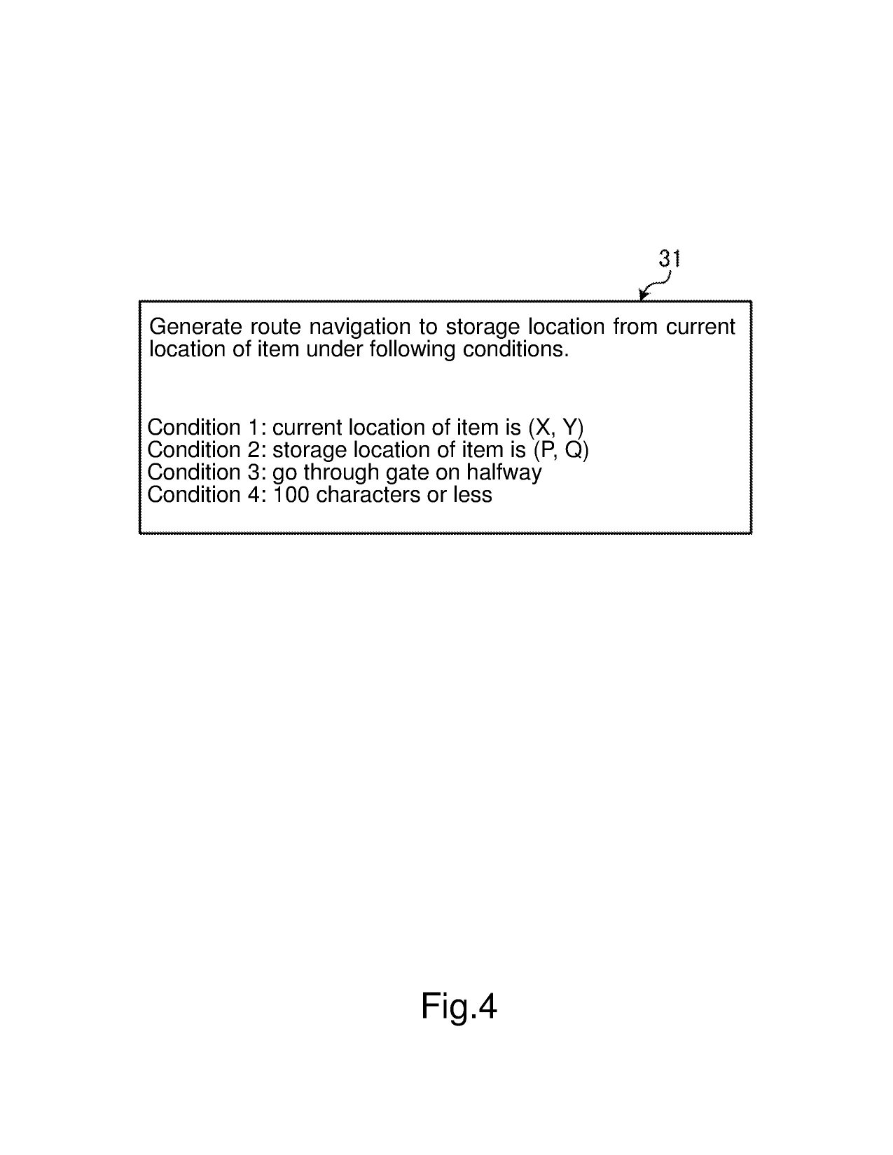

Referring to FIG. 4, a prompt 31 generated by the work instruction apparatus 20 will be described. FIG. 4 is a diagram showing an example of the prompt generated by the work instruction apparatus.

FIG. 4 is an example of the prompt 31 generated by the work instruction apparatus 20. The prompt 31 at least includes an instruction to generate route navigation, the current location of the cart 13, the storage location of the cart 13, and constraint conditions associated with the movement path, and the maximum number of characters of the navigation information.

The instruction to generate route navigation is an instruction to generate route navigation when moving the item (cart 13) from the current location to the storage location.

The current location of the cart 13 is information indicating the installation location of the RFID reader 26, which has read the RFID tag 14 attached to the cart 13. The work instruction apparatus 20 identifies the current location of the cart 13 on the basis of the identification information for identifying the RFID reader 26 itself and the installation location of the RFID reader 26 stored on the map data 224 that the RFID reader 26 outputs when reading the RFID tag 14.

The storage location of the cart 13 is information indicating the storage location stored on the item master 222. The work instruction apparatus 20 identifies the storage location corresponding to the item ID (see FIG. 3) read by the RFID reader 26 from the item master 222.

The constraint conditions associated with the movement path are, for example, constraint conditions that the worker needs to pass through the gates provided with the RFID readers 26 by the time the worker arrives at the storage location.

The maximum number of characters of the navigation information is the maximum number of characters of the navigation information to be generated. The work instruction apparatus 20 presents the generated navigation information to the worker 12 as a voice, so it is desirable to make the navigation information as short as possible so that the worker can remember the information. Therefore, in the example of FIG. 4, the maximum number of characters is set to, for example, 100 or less.

It should be noted that the prompt 31 may include information other than the information shown in FIG. 4.

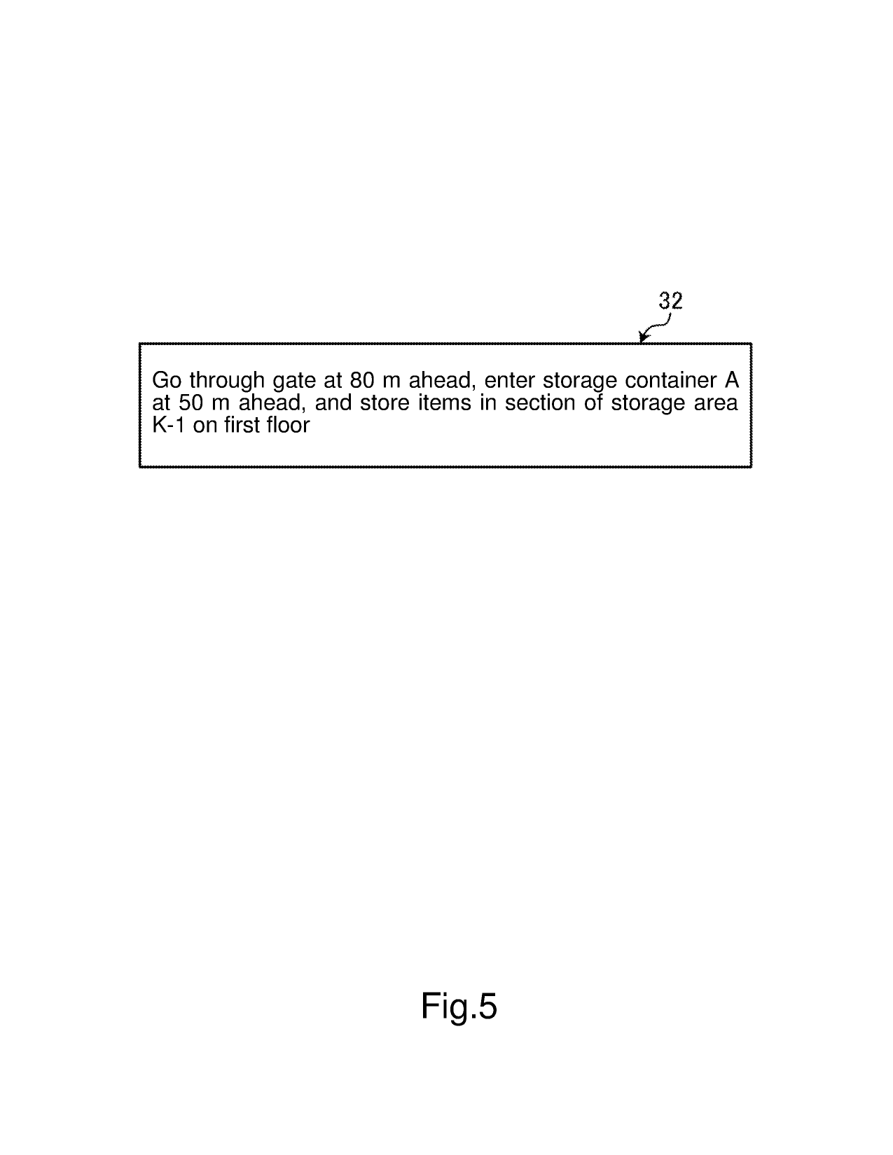

The work instruction apparatus 20 generates navigation information 32 (see FIG. 5) provided to the worker 12 by processing the prompt 31 by means of a natural language processing mechanism using the large language model 225.

### (Navigation Information Generated by Work Instruction Apparatus)

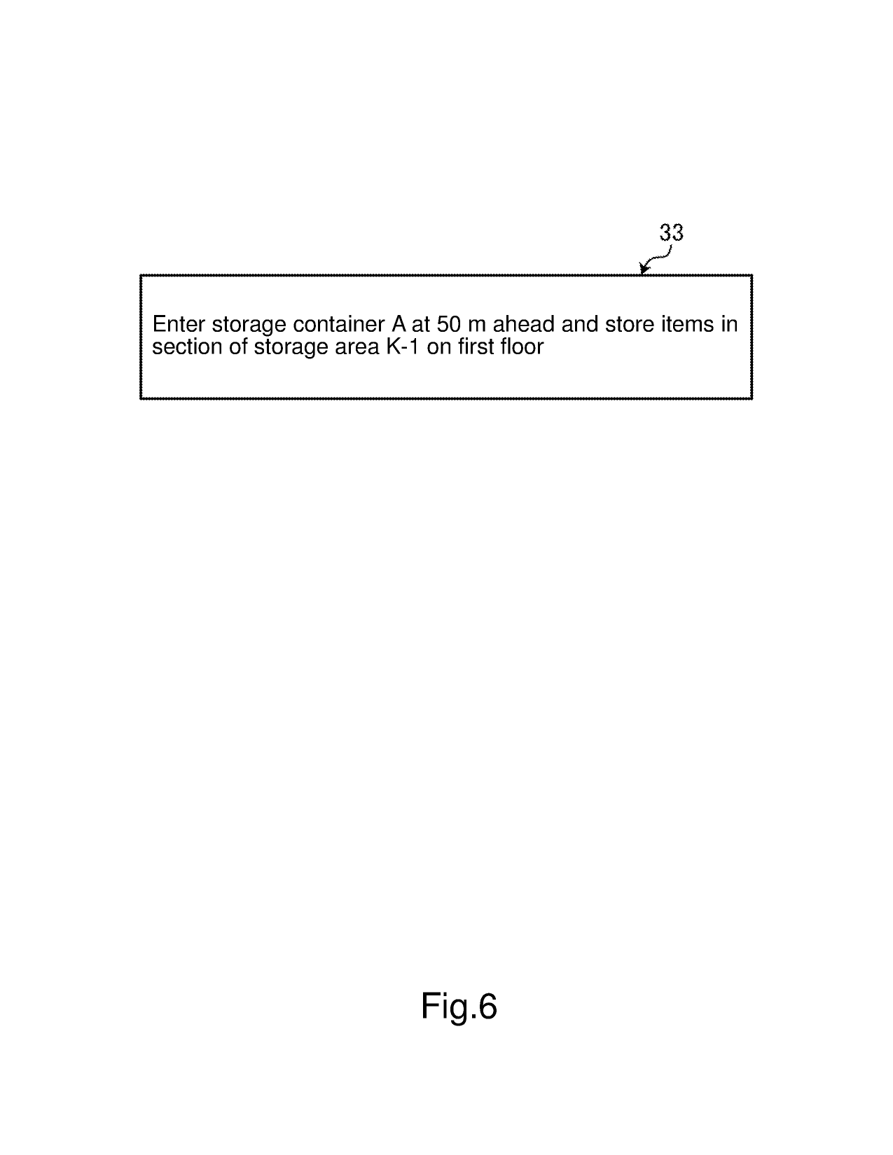

Referring to FIGS. 5 and 6, the navigation information 32 and 33 generated by the work instruction apparatus 20 will be described. FIG. 5 is a first diagram showing an example of the navigation information generated by the work instruction apparatus according to the embodiment. FIG. 6 is a second diagram showing an example of the navigation information generated by the work instruction apparatus according to the embodiment.

The navigation information 32 is navigation information output by the work instruction apparatus 20 when a cart 131 and a worker 121 moving the cart 131 goes through the gate provided with the RFID reader 261.

The navigation information 32 is output from a headset 291 worn by the worker 121 as a voice, e.g., "Go through gate at 80 m ahead, enter storage container A at 50 m ahead, and store items in section of storage area K-1 on first floor."

Then, the worker 121 moves the cart 131, following the route directed by the navigation information 32.

The navigation information 33 is navigation information output by the work instruction apparatus 20 when the cart 131 and the worker 121 moving the cart 131 pass through a gate provided with an RFID reader 262.

The navigation information 33 is output from the headset 291 worn by the worker 121 as a voice, e.g., "Enter storage container A at 50 m ahead and store items in section of storage area K-1 on first floor."

The navigation information 33 is one obtained by deleting the route navigation from the gate provided with the RFID reader 261 to the gate provided with the RFID reader 262, from the navigation information 32. In this manner, every time the worker goes through the gate provided with the RFID reader 26 while moving the cart 13 in accordance with the navigation information, the work instruction apparatus 20 outputs the navigation information for arriving at the storage location of the cart 13 from that point.

### (Functional Configuration of Work Instruction Apparatus)

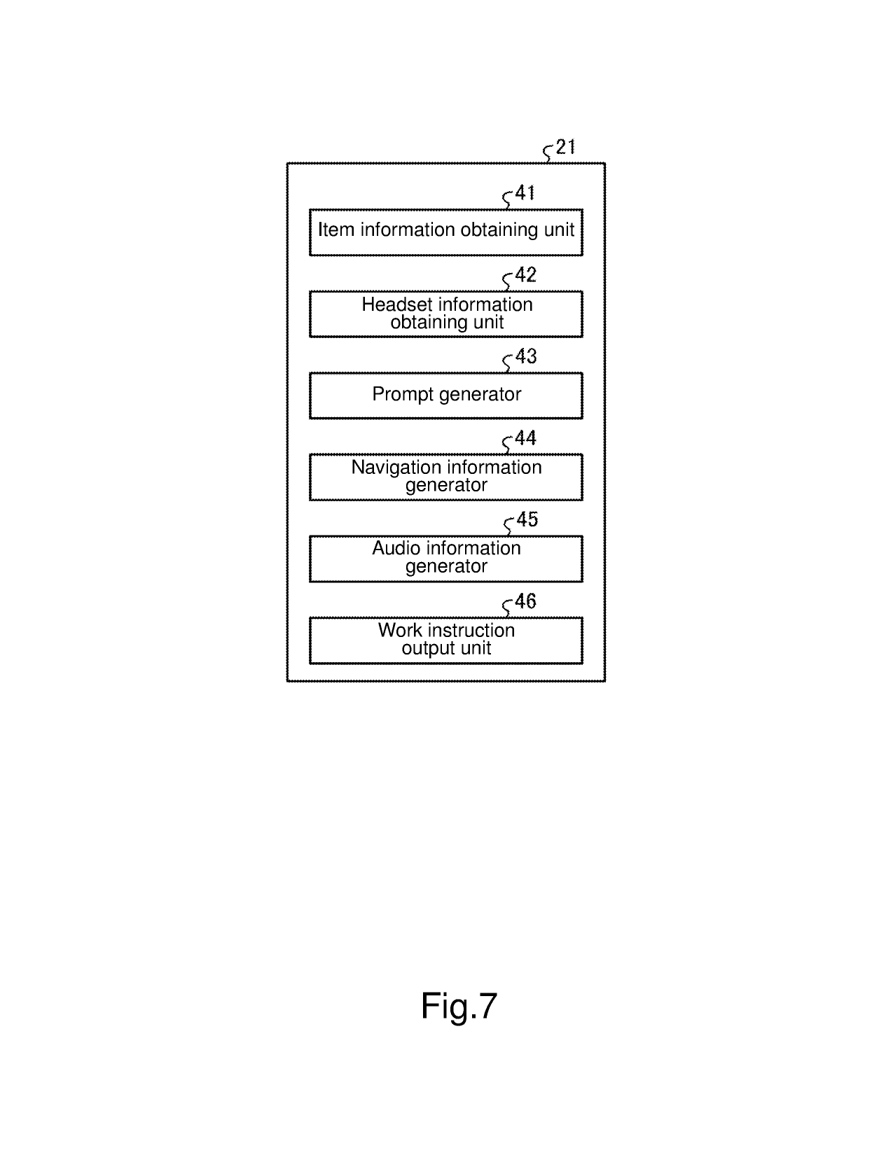

Referring to FIG. 7, a functional configuration of the work instruction apparatus 20 will be described. FIG. 7 is a functional block diagram showing an example of the functional configuration of the work instruction apparatus.

The controller 21 of the work instruction apparatus 20 expands the control program 221 to the RAM 213 and operates the expanded control program 221, thereby realizing an item information obtaining unit 41, a headset information obtaining unit 42, a prompt generator 43, a navigation information generator 44, an audio information generator 45, and a work instruction output unit 46 shown in FIG. 7 as functional parts. It should be noted that some or all of the functional parts may be realized by dedicated hardware.

The item information obtaining unit 41 obtains item transportation information including a current location of the worker 12 and information for identifying the cart 13 (item) moved by the worker 12. More specifically, the item information obtaining unit 41 obtains the current location of the worker 12 and the information for identifying the cart 13 (item) moved by the worker 12 by means of the RFID reader 26. The item information obtaining unit 41 is an example of item transportation information obtaining unit in the present disclosure. It should be noted that the item information obtaining unit 41 may recognize information for identifying the cart 13 moved by the worker 12 by capturing an image of a code symbol, such as a barcode or two-dimensional code attached to the cart 13, with a camera mounted on the gate.

The headset information obtaining unit 42 obtains information for identifying the headset 29 worn by the worker 12 moving the cart 13 in association with the information for identifying the cart 13. More specifically, the item information obtaining unit 41 obtains the information for identifying the headset 29 worn by the worker 12 moving the cart 13 by means of the RFID reader 26. The headset information obtaining unit 42 is an example of an item transportation information obtaining unit in the present disclosure.

The prompt generator 43 generates the prompt 31 (see FIG. 4), which is a generation condition for generating navigation information that navigates the worker 12 moving the cart 13 to the storage location of the cart 13 in the storage container 16. The prompt 31 includes the current location of the worker 12, the storage location of the cart 13 moved by the worker 12 in the storage container 16, the gate location by which the worker has to pass by the time the worker arrives at the storage location, and the like.

On the basis of the item transportation information and the storage location of the cart 13, the navigation information generator 44 generates navigation information including a route for moving the cart 13 to the storage location or to the stop to the storage location from the current location.

The audio information generator 45 converts the navigation information generated by the navigation information generator 44 into audio information. The audio information generator 45 is an example of an information converter in the present disclosure.

The work instruction output unit 46 sends the audio information generated by the audio information generator 45 to the headset 29 worn by the worker 12 moving the corresponding cart 13 and causes the headset 29 to output the audio information.

### (Flow of Processing Performed by Work Instruction Apparatus)

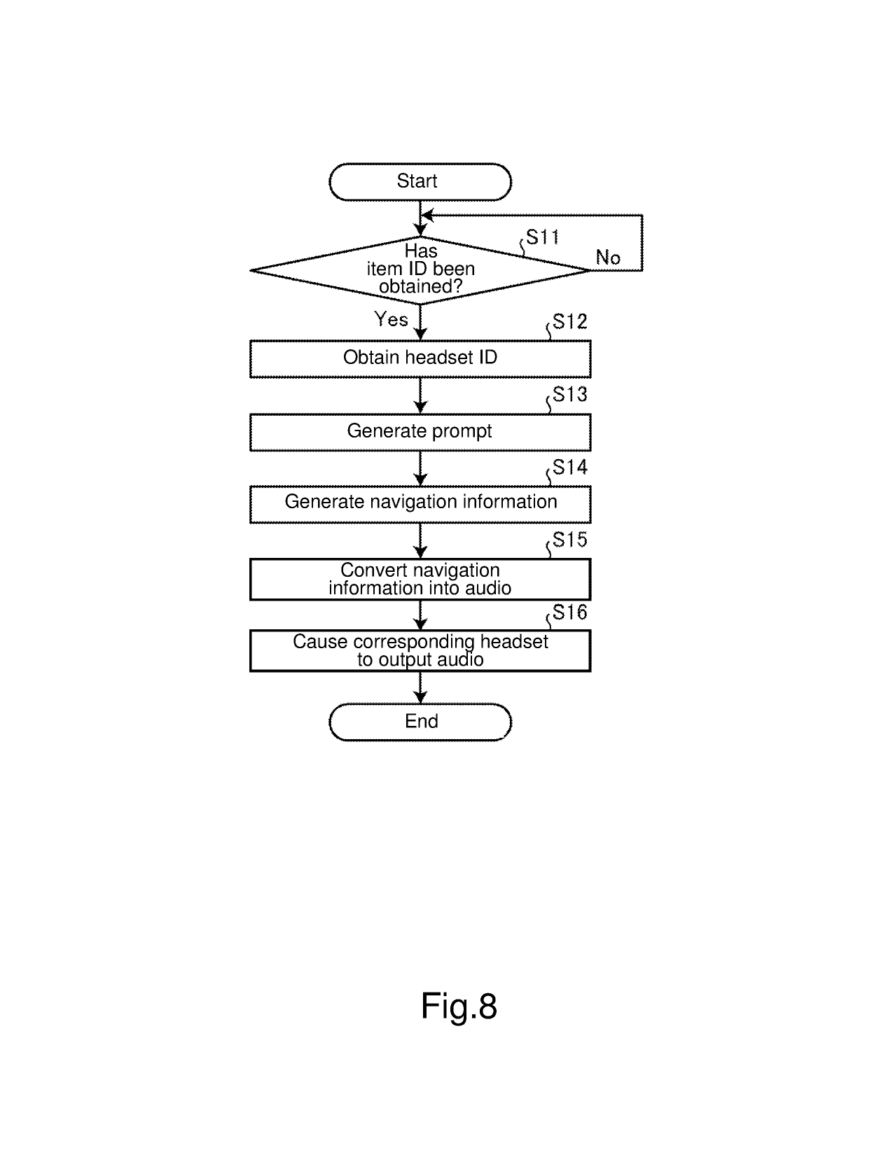

Referring to FIG. 8, a flow of processing performed by the work instruction apparatus 20 will be described. FIG. 8 is a diagram showing an example of the flow of processing performed by the work instruction system according to the embodiment.

The item information obtaining unit 41 determines whether or not the item ID registered on the RFID tag 14 attached to the cart 13 has been obtained (Step S11). In a case where the item information obtaining unit 41 determines that the item ID has been obtained (Step S11: Yes), the item information obtaining unit 41 proceeds to the processing of Step S12. On the other hand, in a case where the item information obtaining unit 41 determines that the item ID has not been obtained (Step S11: No), the item information obtaining unit 41 repeats the determination of Step S11.

In Step S11, in a case where the item information obtaining unit 41 determines that the item ID has been obtained, the headset information obtaining unit 42 obtains a headset ID registered on the RFID tag 15 attached to the headset 29 worn by the worker 12 moving the cart 13 (Step S12). It should be noted that the RFID tag 14 attached to the cart 13 and the RFID tag 15 attached to the headset 29 are actually read at substantially the same time, so the headset information obtaining unit 42 only needs to obtain information of the RFID tag 15 read at substantially the same time as the item information obtaining unit 41 reads the RFID tag 14.

The prompt generator 43 generates a prompt 31, which is a generation condition for generating navigation information to move the cart 13 from the current location to the storage location in the storage container 16 (Step S13).

On the basis of the current location of the worker 12, the information for identifying the cart 13 moved by the worker 12, and the storage location of the cart 13, the navigation information generator 44 generates navigation information 32 including a route for moving the cart 13 to the storage location or to the stop to the storage location from the current location (Step S14).

The audio information generator 45 converts the navigation information generated by the navigation information generator 44 into audio information (Step S15).

The work instruction output unit 46 sends the audio information generated by the audio information generator 45 to the headset 29 worn by the worker 12 moving the corresponding cart 13 and causes the headset 29 to output the audio information (Step S16). Then, the work instruction apparatus 20 repeats the processing of Steps S11 to S16 every time the worker 12 goes through the gate provided with the RFID reader 26.

### (Modified Examples of Embodiment)

The work instruction apparatus 20 may allow the worker to listen to the navigation information 32 or 33 again by a microphone of the headset 29 worn by the worker 12.

For example, if the worker misses the navigation information 32 or 33 or if the worker forgets the navigation information 32 or 33 while moving the cart 13, the worker 12 says "Once more," for example, to the microphone of the headset 29.

The controller 21 of the work instruction apparatus 20 obtains this speech and performs audio recognition. Then, the controller 21 of the work instruction apparatus 20 causes the headset 29 worn by the worker 12 to output the latest navigation information 32 or 33 again. Accordingly, the worker 12 can listen to the navigation information 32 or 33 at any timing again, so the worker can move the cart 13 to the storage location without getting lost.

### (Actions and Effects of Embodiment)

As described above, the work instruction apparatus 20 according to the embodiment obtains the item transportation information including the current location of the worker 12, the information for identifying the cart 13 (item) moved by the worker 12, and the information for identifying the headset 29 worn by the worker 12 by the item information obtaining unit 41 (item transportation information obtaining unit) of the controller 21. On the basis of the item transportation information and the storage location of the cart 13, the work instruction apparatus 20 according to the embodiment generates navigation information 32 including the route for moving the cart 13 to the storage location or to the stop to the storage location from the current location by means of the navigation information generator 44 of the controller 21. The work instruction apparatus 20 according to the embodiment converts the generated navigation information 32 into the audio information by the audio information generator 45 (information converter) of the controller 21. In addition, the work instruction apparatus 20 according to the embodiment causes the headset 29 worn by the worker 12 to output the audio information by means of the work instruction output unit 46 of the controller 21. Therefore, the worker can be allowed to perform the transportation work of the cart 13 (item) with both hands, so the workability is enhanced. Moreover, the navigation information 32 is transferred as a voice, so the worker 12 can reliably pay attention to the surrounding circumstances, and can be prevented from hitting other carts and the like.

Moreover, in the work instruction apparatus 20 according to the embodiment, the navigation information generator 44 generates the navigation information 32 by the natural language processing using the large language model 225. Therefore, more natural navigation information 32 can be generated.

Moreover, in the work instruction apparatus 20 according to the embodiment, the item information obtaining unit 41 (item transportation information obtaining unit) obtains the item transportation information at least once on the transportation route of the cart 13 (item). Therefore, every time the item transportation information is obtained, the navigation information 32 or 33 from its location to the storage location of the cart 13 can be provided.

Moreover, in the work instruction apparatus 20 according to the embodiment, the item information obtaining unit 41 (item transportation information obtaining unit) reads the RFID tag 14 (wireless tag) attached to the cart 13 (item), on which the information for identifying the cart 13 has been registered, by means of the RFID reader 26 (reading device) installed in the predetermined location. Therefore, it is possible to reliably and easily detect the location where the cart 13 is located and the identification information of the cart 13.

Moreover, in the work instruction apparatus 20 according to the embodiment, the item information obtaining unit 41 (item transportation information obtaining unit) reads the RFID tag 15 (wireless tag) attached to the headset 29 worn by the worker 12, on which the information for identifying the headset has been registered, by means of the RFID reader 26 (reading device). Therefore, it is possible to reliably and easily detect the location where the worker 12 is located and the identification information for identifying the headset 29 worn by the worker 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work instruction apparatus that assists transportation work of a worker moving an item to a storage location, comprising:
a communication device configured to be installed in a predetermined location on a transportation route on which an item is moved and wirelessly communicate with a reading device that reads information for identifying the item transported by the worker and information for identifying a headset worn by the worker;
a storage device configured to include an item master in which the storage location of the item is stored corresponding to the information for identifying the item; and
the controller configured to
obtain item transportation information from the reading device via the communication device, the item transportation information including the information for identifying the item transported by the worker and the information for identifying the headset worn by the worker,
refer to the item master and check the storage location of the item corresponding to the obtained information for identifying the item,
generate navigation information on a basis of the item transportation information and the checked storage location of the item, the navigation information including a route for moving the item to the storage location or to a stop to the storage location from a current location,
convert the generated navigation information into audio information, and
cause the headset worn by the worker to output the audio information.

2. The work instruction apparatus according to claim 1, wherein the storage device further includes a large language model, and the controller generates the navigation information by natural language processing using the large language model.

3. The work instruction apparatus according to claim 2, wherein the large language model is a language model learned for generating navigation information that directs a route to move the item to the storage location.

4. The work instruction apparatus according to claim 1, wherein the controller obtains the item transportation information on the transportation route for the item at least once.

5. The work instruction apparatus according to claim 1, wherein a plurality of the predetermined locations in which the reading devices are installed is present on the transportation route.

6. The work instruction apparatus according to claim 5, wherein the controller obtains the item transportation information from a plurality of the reading devices via the communication device, the plurality of reading devices being installed at the plurality of predetermined locations.

7. The work instruction apparatus according to claim 5, wherein on the reading device, information for identifying the reading device is registered, and
the controller obtains the information for identifying the reading device from the reading device together with the item transportation information via the communication device.

8. The work instruction apparatus according to claim 1, wherein to the item, a wireless tag on which the information for identifying the item is registered is attached, and the reading device installed in the predetermined location reads the information for identifying the item from the wireless tag.

9. The work instruction apparatus according to claim 1, wherein the headset has a wireless tag on which the information for identifying the headset is registered, and
the reading device installed in the predetermined location reads the information for identifying the headset from the wireless tag.

10. A work instruction method for a work instruction apparatus that assists transportation work of a worker moving an item to a storage location, comprising:
obtaining item transportation information including a current location of the worker, information for identifying the item transported by the worker, and information for identifying the headset worn by the worker;
generating, on a basis of the item transportation information and the storage location of the item, navigation information including a route for moving the item from the current location to the storage location or to a stop to the storage location;
converting the generated navigation information into audio information; and
causing the headset worn by the worker to output the audio information.
